(19) United States
(12) Patent Application Publication
(10) Pub. No.: US 2009/0069041 A1
(43) Pub. Date: Mar. 12, 2009

(54) SCHEDULING INFORMATION TRANSFER

(75) Inventor: Masato Kitazoe, Tokyo (JP)

Correspondence Address: QUALCOMM INCORPORATED, 5775 MOREHOUSE DR., SAN DIEGO, CA, 92121, US

(73) Assignee: QUALCOMM Incoporated, San Diego, CA (US)

(21) Appl. No.: 12/208,028

(22) Filed: Sep. 10, 2008

Related U.S. Application Data
(60) Provisional application No. 60/971,520, filed on Sep. 11, 2007.

(51) Int. Cl. H04B 7/00

(52) U.S. Cl. 455/509

(57) ABSTRACT

A base station can transmit scheduling unit to mobile device that can enhance mobile device functionality. To transmit the scheduling unit efficiently, the information can be broken down into manageable units. The broken down units can be organized into groupings that enable the units to be sent as a function of available resources. Transmission can continue until a mobile device receives the scheduling unit, where re-organization can occur for a subsequent transmission.

### CLAIM OF PRIORITY UNDER 35 U.S.C. §119

This application claims priority to U.S. Application No. 60/971,520 entitled “METHODS AND APPARATUSES FOR DELIVERY OF SYSTEM INFORMATION IN EVOLVED UNIVERSAL MOBILE TELECOMMUNICATIONS SYSTEM (UMTS) TERRESTRIAL RADIO ACCESS NETWORK (E-UTRAN)”, filed on Sep. 11, 2007. The entirety of which is herein incorporated by reference.

### BACKGROUND

I. Field

The following description relates generally to wireless communications and, more particularly, to transferring scheduling unit.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

MIMO systems commonly employ multiple (N_{T}) transmit antennas and multiple (N_{R}) receive antennas for data transmission. A MIMO channel formed by the N_{T} transmit and N_{R} receive antennas may be decomposed into N_{S} independent channels, which may be referred to as spatial channels, where N_{S}≦{N_{T},N_{R}}. Each of the N_{S} independent channels corresponds to a dimension. Moreover, MIMO systems may provide improved performance (e.g., increased spectral efficiency, higher throughput and/or greater reliability) if the additional dimensionalities created by the multiple transmit and received antennas are utilized.

MIMO systems may support various duplexing techniques to divide forward and reverse link communications over a common physical medium. For instance, frequency division duplex (FDD) systems may utilize disparate frequency regions for forward and reverse link communications. Further, in time division duplex (TDD) systems, forward and reverse link communications may employ a common frequency region. However, conventional techniques may provide limited or no feedback related to channel information.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with a method for delivering system information. The method can include organizing at least one transmission unit into a communication pattern as a function of available resources. Additionally, the method can also include emitting the at least one transmission unit in accordance with the organized communication pattern.

According to another aspect, there can be a wireless communication apparatus. The apparatus can comprise an arranger that organizes at least one transmission unit into a communication pattern as a function of available resources and a sender that emits the at least one transmission unit in accordance with the organized communication pattern.

In a further aspect, there can be a wireless communications apparatus that includes means for organizing at least one transmission unit into a communication pattern as a function of available resources. Moreover, the apparatus can also include means for emitting the at least one transmission unit in accordance with the organized communication pattern.

With yet another aspect, there can be a computer program product having stored thereon a computer program product comprising a computer readable medium having code for organizing at least one transmission unit into a communication pattern as a function of available resources. There can also be code for emitting the at least one transmission unit in accordance with the organized communication pattern.

Still another aspect can include in a wireless communication system, an apparatus comprising a processor. The processor can be configured to organize at least one transmission unit into a communication pattern as a function of available resources. In addition, the processor can be configured to emit the at least one transmission unit in accordance with the organized communication pattern.

In accordance with one or more embodiments and corresponding disclosure thereof, various aspects are described in connection with a method for processing scheduling unit. The method can comprise collecting a transmission unit package produced from a base station that arranges the package based upon available resources. Moreover, the method can comprise identifying at least one transmission unit in a collected transmission unit package.

According to another aspect, there can be a wireless communication apparatus that includes a gatherer that collects a transmission unit package produced from a base station that arranges the package based upon available resources. Additionally, the apparatus can include an classifier that identifies at least one transmission unit in a collected transmission unit package.

In a further aspect, there can be a wireless communication apparatus that comprises means for collecting a transmission unit package produced from a base station that arranges the package based upon available resources. The apparatus can also comprise means for identifying at least one transmission unit in a collected transmission unit package.

With yet another aspect, there can be a computer program product having stored thereon a computer program product comprising a computer readable medium having code for collecting a transmission unit package produced from a base station that arranges the package based upon available resources. There can also be code for identifying at least one transmission unit in a collected transmission unit package.

Still another aspect can include in a wireless communication system, an apparatus comprising a processor. The processor can be configured to collect a transmission unit package produced from a base station that arranges the package based upon available resources as well as identify at least one transmission unit in a collected transmission unit package.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of an example wireless communication system in accordance with various aspects set forth herein.

FIG. 2 is an illustration of an example communication system for transfer of scheduling unit in accordance with various aspects set forth herein.

FIG. 3 is an illustration of an example communication system for transfer of scheduling unit that decomposes a scheduling packet into at least one transmission unit in accordance with various aspects set forth herein.

FIG. 4 is an illustration of an example communication system for transfer of scheduling unit that manages multiple transfers in accordance with various aspects set forth herein.

FIG. 5 is an illustration of an example communication system for transfer of scheduling unit manages multiple pattern organizations that in accordance with various aspects set forth herein.

FIG. 6 is an illustration of an example communication system for transfer of scheduling unit that checks if information is previously obtained in accordance with various aspects set forth herein.

FIG. 7 is an illustration of an example communication system for transfer of scheduling unit that reconstructs a scheduling package in accordance with various aspects set forth herein.

FIG. 8 is an illustration of an example communication system for transfer of scheduling unit that requests for further information in accordance with various aspects set forth herein.

FIG. 9 is an illustration of example communication of scheduling unit in accordance with various aspects set forth herein.

FIG. 10 is an illustration of an example methodology for transferring scheduling unit in accordance with various aspects set forth herein.

FIG. 11 is an illustration of an example methodology for processing scheduling unit in accordance with various aspects set forth herein.

FIG. 12 is an illustration of an example mobile device that facilitates communication of scheduling unit.

FIG. 13 is an illustration of an example system that facilitates communication of scheduling unit.

FIG. 14 is an illustration of an example wireless network environment that can be employed in conjunction with the various systems and methods described herein.

FIG. 15 is an illustration of an example system that facilitates transfer of scheduling unit in accordance with various aspects set forth herein.

FIG. 16 is an illustration of an example system that processing of scheduling unit in accordance with various aspects set forth herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station may be utilized for communicating with mobile device(s) and may also be referred to as an access point, Node B, or some other terminology.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, a computer readable medium wireless channels and various other media capable of storing, containing, and/or carrying instruction(s) and/or data.

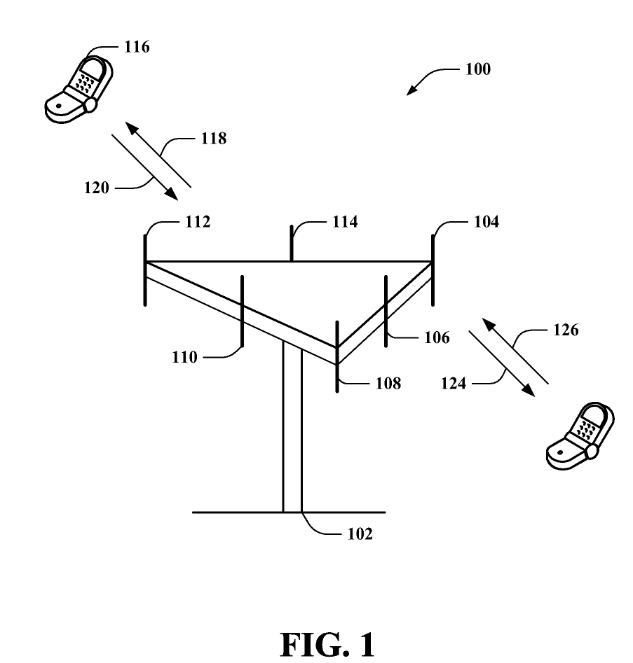

Referring now to FIG. 1, a wireless communication system 100 is illustrated in accordance with various embodiments presented herein. System 100 comprises a base station 102 that may include multiple antenna groups. For example, one antenna group may include antennas 104 and 106, another group may comprise antennas 108 and 110, and an additional group may include antennas 112 and 114. Two antennas are illustrated for each antenna group; however, more or fewer antennas may be utilized for each group. Base station 102 may additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 may communicate with one or more mobile devices such as mobile device 116 and mobile device 122; however, it is to be appreciated that base station 102 may communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 may utilize a different frequency band than that used by reverse link 120, and forward link 124 may employ a different frequency band than that employed by reverse link 126, for example. Further, in a time division duplex (TDD) system, forward link 118 and reverse link 120 may utilize a common frequency band and forward link 124 and reverse link 126 may utilize a common frequency band.

The set of antennas and/or the area in which they are designated to communicate may be referred to as a sector of base station 102. For example, multiple antennas may be designed to communicate to mobile devices in a sector of the areas covered by base station 102. In communication over forward links 118 and 124, the transmitting antennas of base station 102 may utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells may be subject to less interference as compared to a base station transmitting through a single antenna to all its mobile devices.

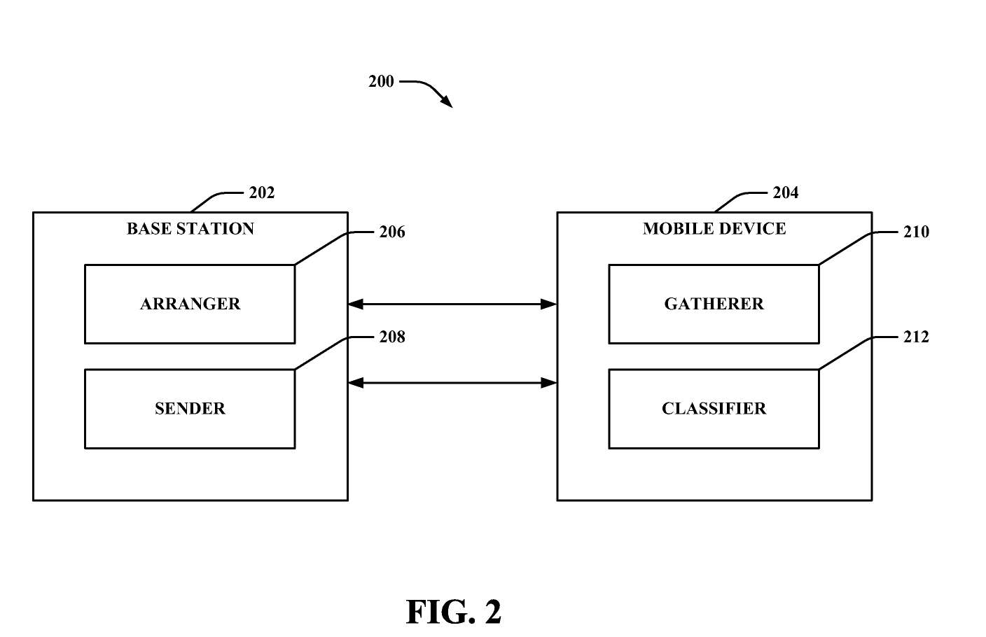

Now referring to FIG. 2, an example system 200 is disclosed where a base station 202 transfers scheduling unit to a mobile device 204. Scheduling unit can be delivered from the base station 202 at opportunistic times as a function of available resources (e.g., at a time when appropriate resources are available and/or anticipated to be available). Analysis can be performed upon the resources and based upon a result of the analysis an arranger 206 can organize at least one transmission unit into a communication pattern as a function of available resources. Commonly, organization includes placement of transmission units into groupings. A sender 208 can emit the at least one transmission unit in accordance with the organized communication pattern (e.g., as part of a grouping). The base station 202 can transfer the scheduling unit to multiple mobile devices 204 and/or in multiple occurrences. According to one embodiment, once an arrangement is made then the arrangement is used until communication is complete—however, different arrangements can be used if resource availability changes.

As scheduling unit is emitted from the base station 202, the mobile device 204 can process and appreciate that information. A gatherer 210 can collect a transmission unit package produced from the base station 202 that arranges the package based upon available resources. In addition, the mobile device 204 can use a classifier 212 that identifies at least one transmission unit in a collected transmission unit package. While disclosing scheduling unit transfer, it is to be appreciated that other types of information can be transferred in accordance with aspects disclosed herein.

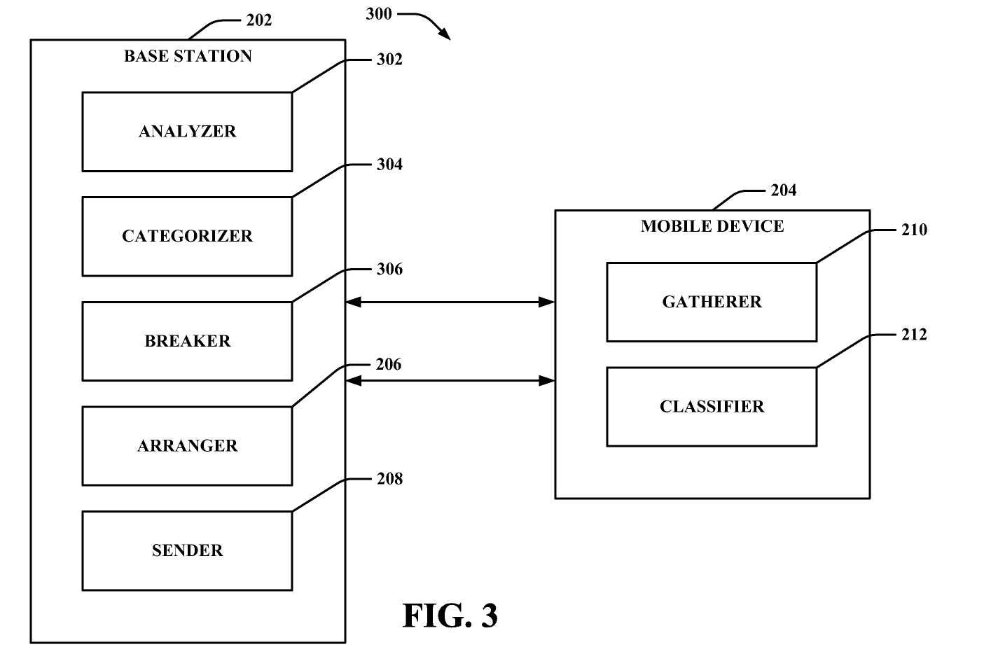

Now referring to FIG. 3, an example system 300 is disclosed for dividing a scheduling unit package and transferring the package to a mobile device 204. A base station 202 can identify scheduling unit that can be beneficial for the mobile device 204 and create a scheduling unit package. An analyzer 302 can determine available resources upon which organization can be based. In addition, a result of the analysis can be used to determine a size of a transmission unit.

A categorizer 304 can define a size of the at least one transmission unit (e.g., a transmission unit is a part of scheduling unit)—the definition can be based upon a result of the analysis. Commonly, the transmission unit is relatively small and about evenly distributable (e.g., transmission units are about that same size) and of equal size across different transmission sessions. With a size defined, a breaker 306 can divide a scheduling unit into at least one transmission unit of the defined size. In addition to providing divisions, the breaker 306 can perform diagnostic test, such as determining if information is correctly divided.

An arranger 206 can organize at least one defined transmission unit into a communication pattern as a function of available resources determined by the analyzer 302. A sender 208 can emit the at least one transmission unit produced from the breaker 306 in accordance with the organized communication pattern. The transmission unit can move to the mobile device 204 that uses a gatherer 210 that collects a transmission unit package produced from a base station that arranges the package based upon available resources. Moreover, a classifier 212 can be used that identifies at least one transmission unit in a collected transmission unit package.

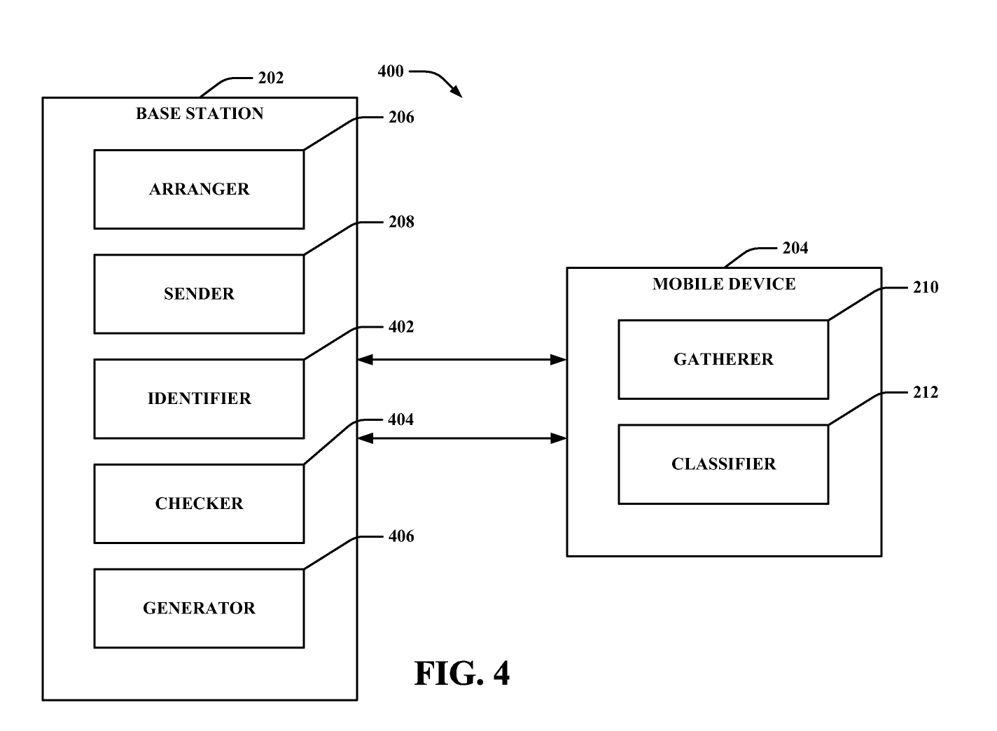

Now referring to FIG. 4, an example system 400 is disclosed for multiple transmissions of scheduling unit between a base station 202 and a mobile device 204. The base station 202 can use an arranger 206 and/or a sender 208 that can facilitate communication of scheduling unit. Due to various factors, scheduling unit that is emitted from the base station 202 might not reach the mobile device 204. This can occur globally (e.g., no transmission unit reaches the mobile device 204) or partially (e.g., some transmission units arrive while some do not arrive).

Thus, the base station 202 can configure such that scheduling unit is transferred multiple times in an attempt to convey the information to the mobile device 204. Additionally, the scheduling unit can be generally emitted, such that a mobile device 204 within a projection range can appreciate the scheduling unit. An identifier 402 can discover entry of a mobile device with a coverage area, the discovered mobile device can obtain at least one transmission unit. It is possible that scheduling information is sensitive in nature, and the base station 202 can use a checker 404 that determines if the discovered mobile device should receive at least of transmission unit, the determination is made as a function of security (e.g., through use of artificial intelligence techniques). A generator 406 can create a log of the mobile device receiving at least one transmission unit from the sender 208 Thus, the checker 404 can refer to the log to determine security analysis is recorded for a mobile device and thus less analysis should occur—therefore, resources can be saved.

Artificial intelligence techniques can be used in various aspects disclosed herein. These techniques can employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

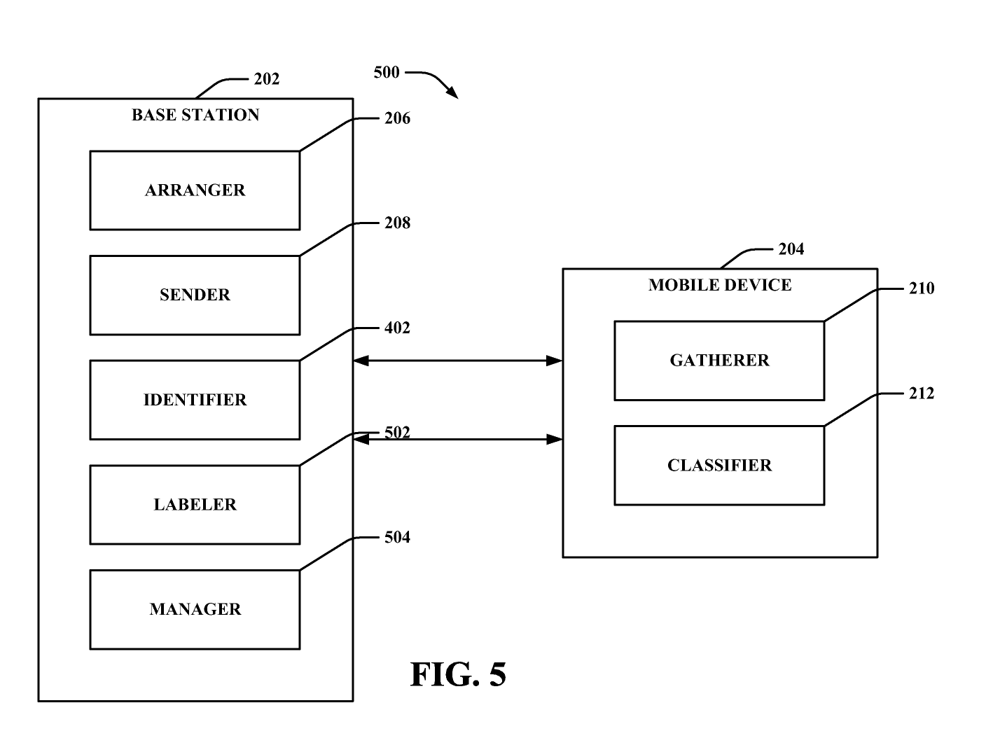

Now referring to FIG. 5, an example system 500 is disclosed for multiple transmissions of scheduling unit between a base station 202 and a mobile device 204 with resource management. An arranger 206 can organize transmission units and a sender 208 can emit the transmission units in the manner organized by the arranger 206. Commonly the emission of the sender 208 is broad (e.g., dispersed throughout a coverage area as opposed to directed to a specific mobile device) and can be accessed by multiple mobile devices.

An identifier 402 can be used that discovers entry of a mobile device with a coverage area, the discovered mobile device can obtain at least one transmission unit. A labeler 502 can determine when there is no mobile device within the coverage area and a manager 504 can deactivates the sender 208 upon a positive determination of the labeler 502. Thus, if there are no mobile devices that can receive the scheduling unit, then it can be a waste of resources to transmit and therefore the sender 208 can stop operation. However, it is to be appreciated that the system 500 can operate cautiously even if there is no mobile device within a coverage area (e.g., transmission units are still emitted).

In addition, the identifier 402 can be used to determines (e.g., through artificial intelligence techniques) available resources upon which the organization is based that is performed by the arranger. After emission of the scheduling unit, another transfer can be appropriate—however, it is possible that resource availability changes and thus there should be a change in organization (e.g., the arranger should operate again). The base station 202 can use the manager 504 that repeats operation of the arranger 206 such that there is organizing at least one transmission unit into a communication pattern as a function of available resources, repeating emission of the at least one transmission unit is performed in accordance with the repeated organization.

The mobile device 204 can request that scheduling unit be transferred multiple times in the same pattern, thus requesting that the manager 504 be non-functional—the base station 202 can determine if the request should be honored. The mobile device 204 can use a gather 210 to collect transmission units and a classifier 212 to identify units that are part of a grouping.

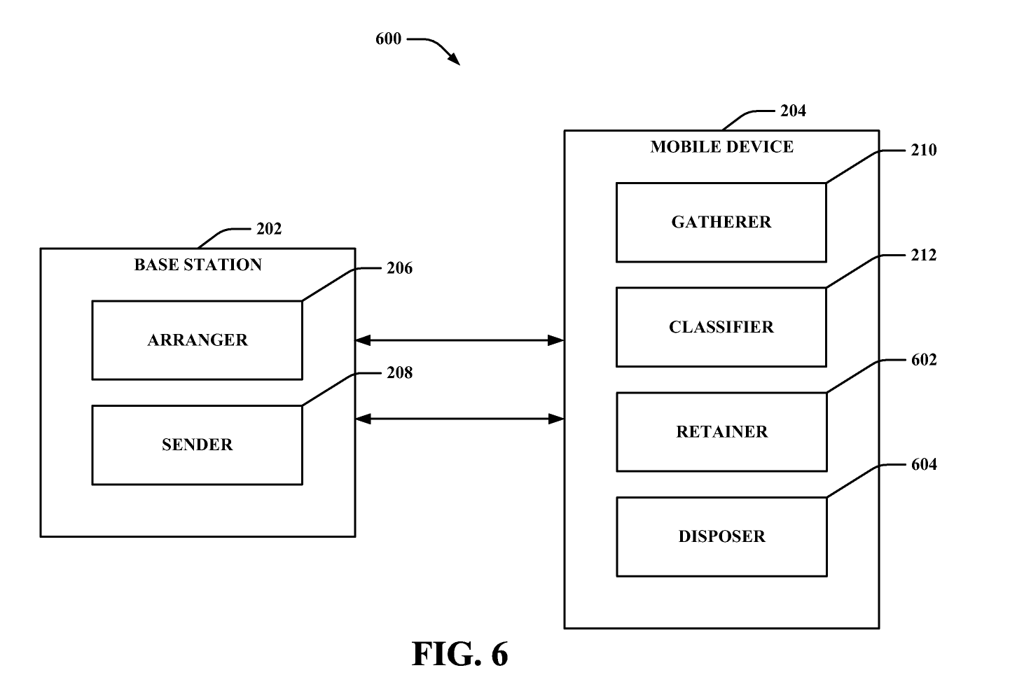

Now referring to FIG. 6, an example system 600 is disclosed for processing scheduling unit transferred from a base station 202. The base station 202 can use an arranger 206 that places transmission units into groupings based upon available resource (e.g., time windows where fewer resources are consumed by other functions can be used to communicate more scheduling unit). A sender 208 can be employed to emit the groupings at appropriate times.

Communication can be facilitated between the base station 202 and mobile device 204 such that scheduling unit is transferred. A gatherer 210 can collect scheduling unit and a classifier 212 can identify transmission units. According to one embodiment, encryption techniques can be used to protect the scheduling unit. For example, prior to emission, the sender 208 and gathered 210 can authenticate one another and enter into a secure communication (e.g., based upon hard-coding at production time).

It is possible that transmission units are lost and thus the base station 202 can emit scheduling unit multiple times. Upon collection of a subsequent emission, a retainer 602 can determine if the identified transmission unit is already appreciated. If the transmission unit is previously appreciated (e.g., collected, extracted, and placed into a package), then a disposer 604 can discard the identified transmission unit.

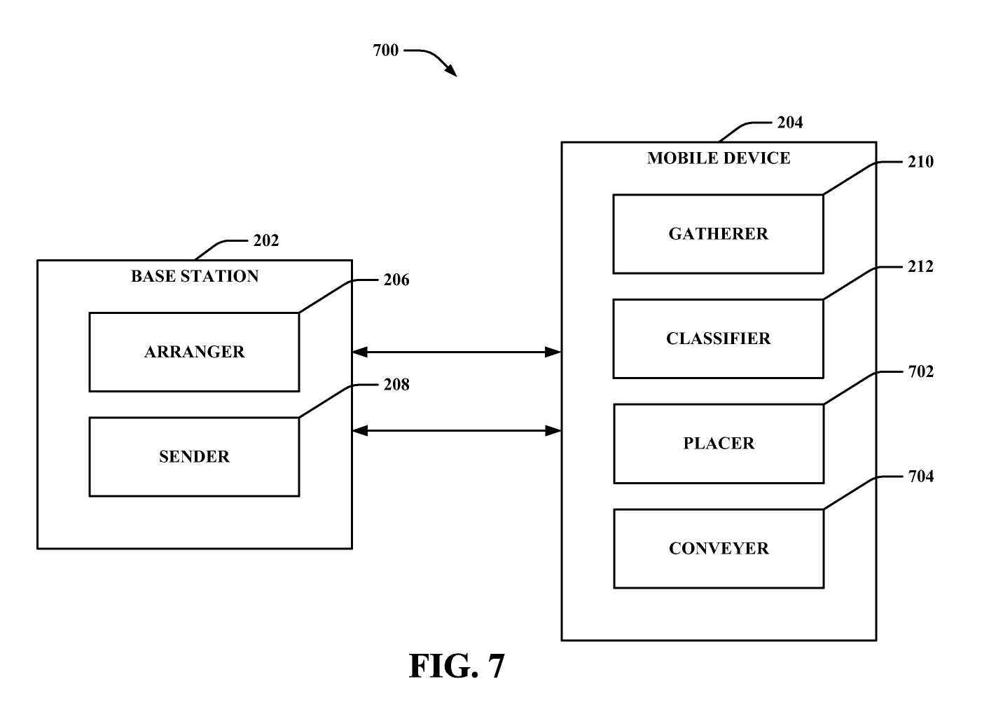

Now referring to FIG. 7, an example system 700 is disclosed for processing scheduling unit transferred from a base station 202. Scheduling unit can be communicated from a base station 202 to at least one mobile device 204. It can be unlikely to find a window to communicate an entire package of scheduling unit, so the scheduling unit can be divided into transmission units. An arranger 206 can organize transmission units into packages based upon resources available and a sender 208 can securely transmit the scheduling unit at designated times.

A mobile device 204 can collect the emitted schedule information with a gatherer 210 and identify particular transmission units with a classifier 212. The classifier 212 can extract the transmission unit and a placer 702 can arrange at least one identified transmission unit in a scheduling unit sequence. For example, a transmission unit can be 4^{th} out of seven in a sequence—the placer 702 can arrange the transmission unit in an appropriate place in the sequence (e.g., 4^{th} place). The placer 702 can analyze the sequence to determine when appropriate information is known (e.g., all sequence portions are collected and/or appreciated). A conveyer 704 can send confirmation that the scheduling unit sequence is complete at an appropriate time. This information can be used by the base station 202 or a central server to track efficiency and improve operation.

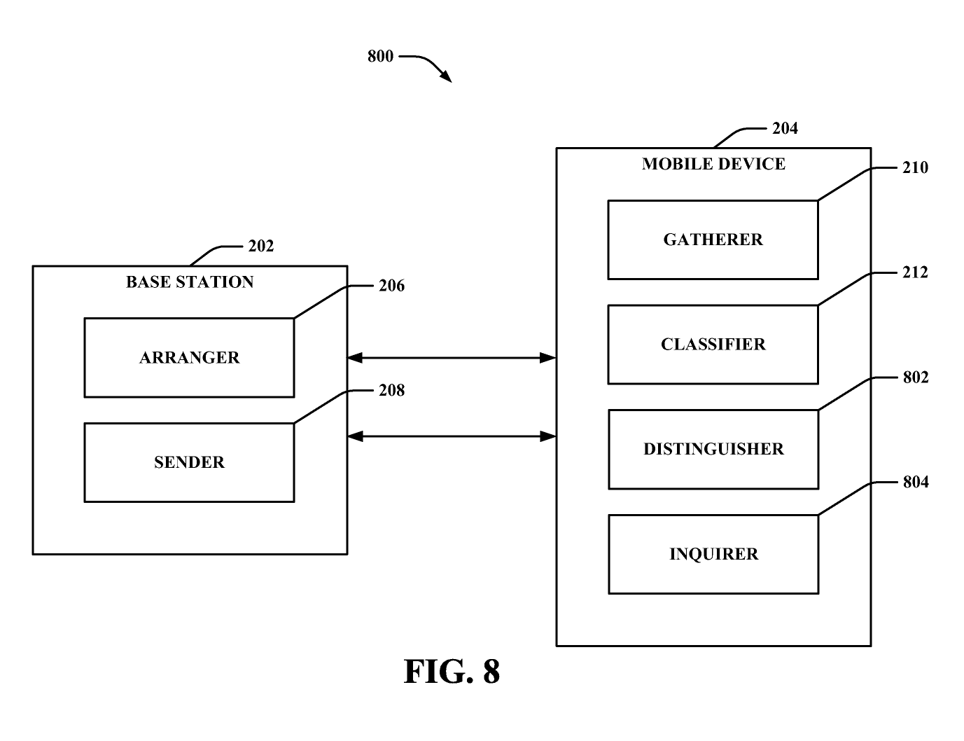

Now referring to FIG. 8, an example system 800 is disclosed for processing scheduling unit transferred from a base station 202. Scheduling unit can transfer from a base station 202 to at least one mobile device 204. The scheduling unit can be broken-down into transmission units and transmitted in accordance with available resources. An arranger 206 can obtain resource information and place transmission units into groupings based upon available resources. A sender 208 can determine when resources are available and transmit the scheduling unit. According to one embodiment, groupings can be sequential (e.g., transmission units near one another are transferred together, such as a first and second transmission unit), random, and the like.

A mobile device 204 can collect the emitted schedule information with a gatherer 210 and identify particular transmission units with a classifier 212. The classifier 212 can determine when the scheduling unit communication is finished. A distinguisher 802 can evaluate what is collected and recognize that at least one transmission unit is missing such that a scheduling unit sequence is not complete (e.g., a grouping is not properly communicated). An inquirer 804 can request retransmission of scheduling unit (e.g., all information, only portions not received, and the like) of which the base station 202 can follow in whole, in part, ignore, etc.

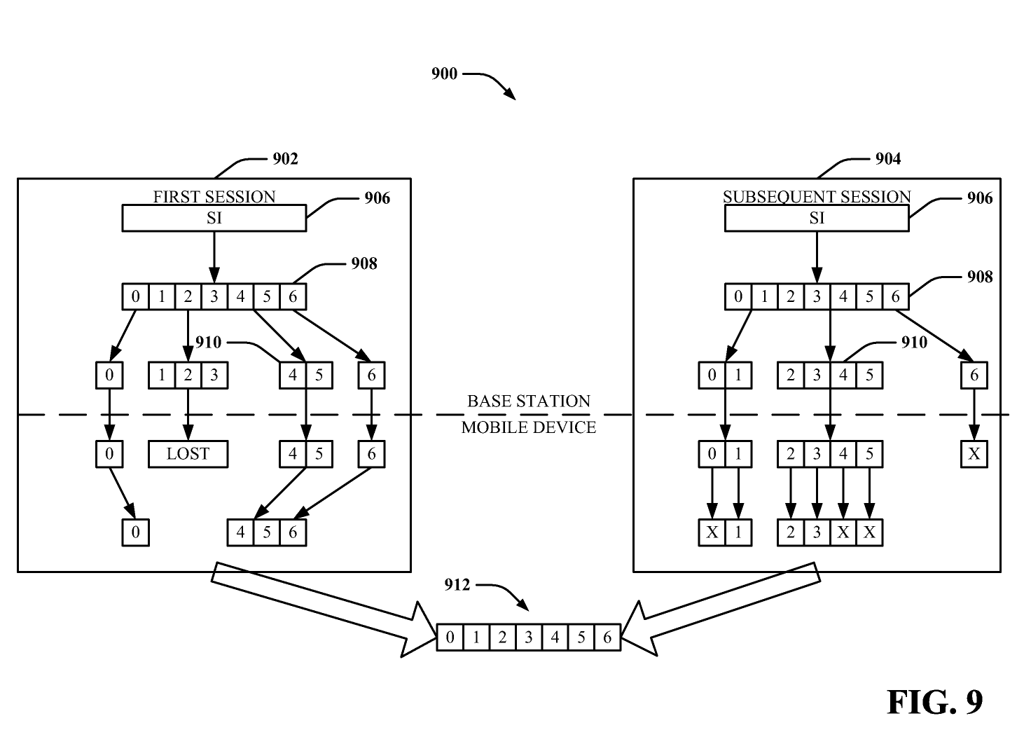

Now referring to FIG. 9, an example communication session 900 is disclosed with a first session 902 and a subsequent session 904. Scheduling unit (SU) 906 can be defined as individual transmission units 908 (e.g., functioning of the categorizer 304 of FIG. 3 and/or the breaker 306 FIG. 3) and organized into groupings 910 based upon available resources (e.g., by an arranger 206 of FIG. 2). The aforementioned processing of scheduling unit can occur at a base station.

The groupings can be transmitted toward a mobile device, where the mobile device can recognize transmission units and place the units into a package to recreate the SU 906. However, it is possible for portions become lost in transmission (e.g., a grouping of transmission units 2 and 3). Therefore, a subsequent session 904 can be run based upon a different resource allocation. The mobile device can identify packages and/or transmission units already appreciated and discard them (e.g., denoted with an ‘X’). In addition, the mobile device can arrange received transmission units and organize them into a scheduling package 912.

There can be use a mechanism based on Radio Resource Control (RRC) level segmentation. An RRC packet can include: sequence number of the first TU in the packet, a last packet indicator, a number of TU in the packet, and at least one transmission unit. Since it is done in RRC, the corresponding Abstract Syntax Notation One (ASN.1) could be something like the following.

SchedulingUnitSegment ::= SEQUENCE {

| | |
|---|---|
| sequenceNumber | INTEGER (0..N), |
| lastPacketIndicator | BOOLEAN, |
| transmissionUnitList | TransmissionUnit-List |

}

TransmissionUnit-List ::= SEQUENCE (SIZE (1..maxTU)) OF
TransmissionUnit
TransmissionUnit ::= BIT STRING (SIZE (X))

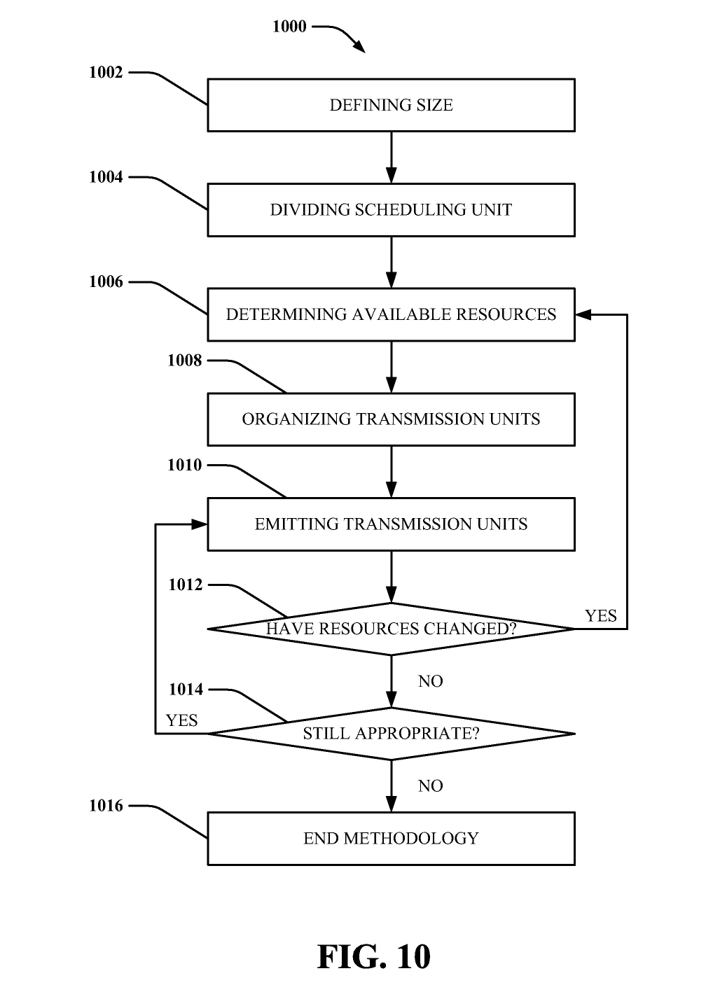

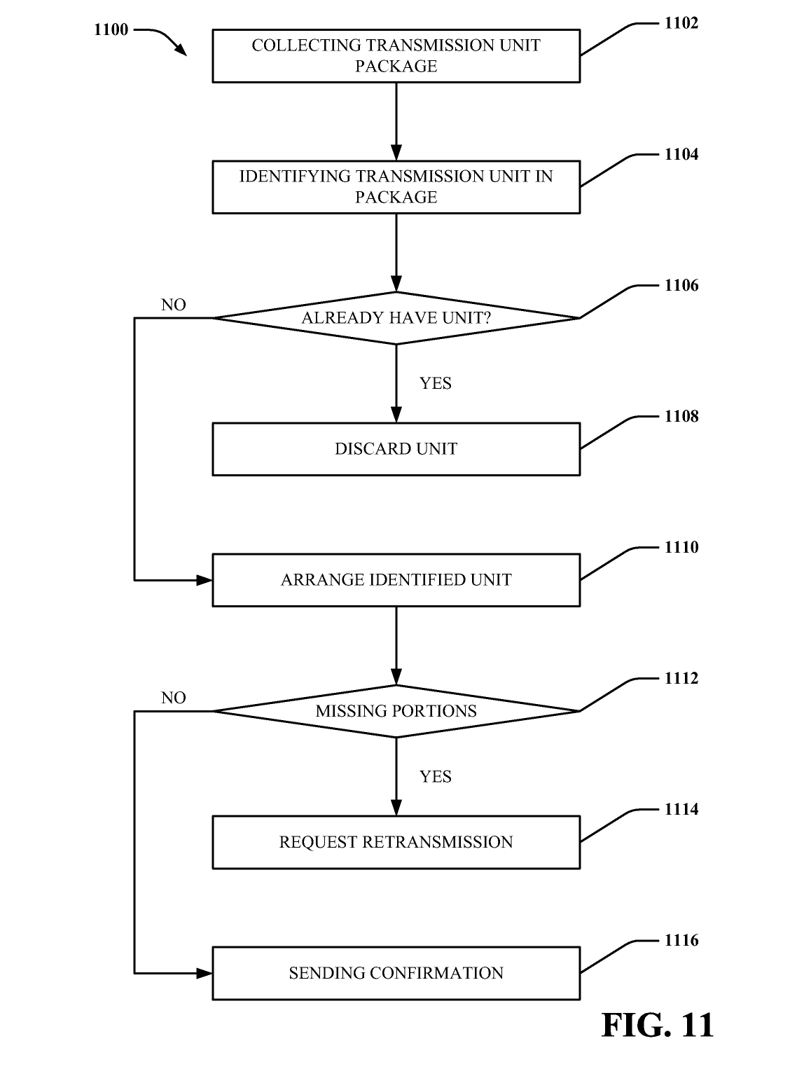

Referring to FIGS. 10-11, methodologies relating to facilitating communication of scheduling unit between a base station and mobile device. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

It will be appreciated that, in accordance with one or more aspects described herein, inferences can be made regarding processing a scheduling unit. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences regarding transfer of scheduling units. It will be appreciated that the foregoing examples are illustrative in nature and are not intended to limit the number of inferences that can be made or the manner in which such inferences are made in conjunction with the various embodiments and/or methods described herein.

Now referring to FIG. 10, an example methodology 1000 is disclosed for transferring scheduling unit, commonly from a base station to a mobile device. Commonly, scheduling unit is too large (e.g., is too many bits) to transmit in one scheduling block over the air—therefore smaller transmission units can be used in information transmission. There can be defining a size of the at least one transmission unit (e.g., a smallest size, such as one bit) at action 1002. Diagnostic tests can be run to ensure the defined size is feasible to operate and then there can be dividing a scheduling unit into at least one transmission unit of the defined size at event 1004.

Commonly, predictions can occur (e.g., through use of artificial intelligence techniques) on how information is communication and thus how resources are used. There can be determining available resources upon which the organization is based at action 1006, typically based upon the predictions. According to one embodiment, defining size and/or dividing the scheduling unit can be performed as a function on available resources.

Organizing at least one transmission unit into a communication pattern as a function of available resources can take place at event 1008. Metadata related to an intended mobile device can be collected, such as locations, communication frequency, security parameters, and the like. These parameters can be used at act 1010 in conjunction with emitting the at least one transmission unit in accordance with the organized communication pattern (e.g., emitted to the intended mobile device).

Due to a variety of factors (e.g., weather, interference, physical malfunction, etc.), there can be potential that not all transmission units reach a mobile device and transmission units can be continuously sent. However, resources can change in a base station and therefore, a check 1012 can determine if there is a resource change. If the resources have changed, then the methodology 1000 can return to action 1006. In addition, another check 1014 can be run to determine if sending transmission units is still appropriate. For example, check 1014 can include discovering entry of a mobile device with a coverage area, the discovered mobile device can obtain at least one transmission unit and determining if the discovered mobile device should receive at least of transmission unit, the determination can made as a function of security. If it is determined that the mobile device is not secure (e.g., not authorized to collect scheduling information), then the methodology 1000 can end at act 1016 and emission can stop.

In addition, the check 1014 to determine if emission is still appropriate could be a matter of conservation as opposed to security. Thus, the check 1014 can include determining when there is no mobile device within the coverage area as well as deactivating the emitter upon a positive determination of a labeler. At act 1016 there can be creating a log of the mobile device receiving at least one transmission unit from the sender.

However, if the threshold is not surpassed and/or met, then the methodology 1000 can be designated to again send scheduling unit. A check 1018 can be run to determine if there should be reorganization, commonly due to a change in resource allocation and/or needs of the mobile device. If reorganization should occur, then event 1008 can function as repeating organizing at least one transmission unit into a communication pattern as a function of available resources, repeating emission of the at least one transmission unit is performed in accordance with the repeated organization. After reorganization or if check 1018 determines reorganization is not appropriate, then act 1010 can operate as repeating emitting the at least one transmission unit until confirmation is collected that the at least one transmission unit is obtained or until a set number of emissions occurs. Repeated emission can be of all transmission units, part of the transmission units, transmission units missing from a mobile device, and the like.

Now referring to FIG. 11, an example methodology 1000 is disclosed for processing scheduling unit. At action 1102, there can be collecting a transmission unit package produced from a base station that arranges the package based upon available resources. Commonly, collection can include scanning for malicious content (e.g., viruses), performing security measures (e.g., decrypting), identifying a base station that emits the transmission unit package, and the like.

At act, 1104 there can be identifying at least one transmission unit in a collected transmission unit package. A check 1106 can function determining if the identified transmission unit is already appreciated (e.g., analyzed, placed into a constructed sequence, and the like). If the transmission unit is already appreciated, then action 1108 can function discarding the identified transmission unit if the transmission unit is already appreciated.

However, if the transmission unit has not already been appreciated, then event 1110 can function arranging at least one identified transmission unit in a scheduling unit sequence. Another check 1112 can operate to determine if there is a portion missing from the scheduling unit sequence. If there is a portion missing, then action 1114 can function as requesting retransmission of scheduling unit. Thus, check 1112 can operate as recognizing that at least one transmission unit is missing such that a scheduling unit sequence is not complete. If no portion is missing, then event 1116 can implement as sending confirmation that the scheduling unit sequence is complete.

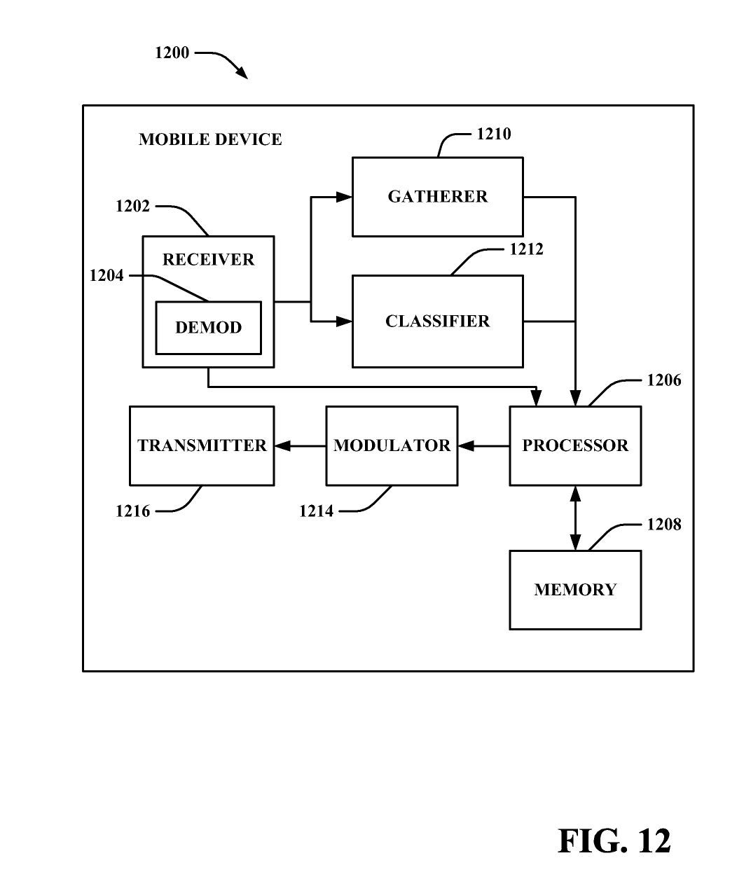

FIG. 12 is an illustration of a mobile device 1200 that facilitates communication of scheduling unit. Mobile device 1200 comprises a receiver 1202 that receives a signal from, for instance, a receive antenna (not shown), and performs typical actions thereon (e.g., filters, amplifies, downconverts, etc.) the received signal and digitizes the conditioned signal to obtain samples. Receiver 1202 can be, for example, an MMSE receiver, and can comprise a demodulator 1204 that can demodulate received symbols and provide them to a processor 1206 for channel estimation. Processor 1206 can be a processor dedicated to analyzing information received by receiver 1202 and/or generating information for transmission by a transmitter 1216, a processor that controls one or more components of mobile device 1200, and/or a processor that both analyzes information received by receiver 1202, generates information for transmission by transmitter 1216, and controls one or more components of mobile device 1200.

Mobile device 1200 can additionally comprise memory 1208 that is operatively coupled to processor 1206 and that may store data to be transmitted, received data, information related to available channels, data associated with analyzed signal and/or interference strength, information related to an assigned channel, power, rate, or the like, and any other suitable information for estimating a channel and communicating via the channel. Memory 1208 can additionally store protocols and/or algorithms associated with estimating and/or utilizing a channel (e.g., performance based, capacity based, etc.).

It will be appreciated that the data store (e.g., memory 1208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 of the subject systems and methods is intended to comprise, without being limited to, these and any other suitable types of memory.

Processor 1202 is further operatively coupled to a gatherer 1210 that collects a transmission unit package produced from a base station that arranges the package based upon available resources. In addition, the processor 1202 can be operatively coupled to a classifier 1212 that identifies at least one transmission unit in a collected transmission unit package. A comparison can be made against previously retained transmission units to determine if there is redundancy. If there is redundancy, then the transmission unit can be discarded. However, if the transmission unit is not known, then the transmission unit can be placed into a scheduling unit sequence. Mobile device 1200 still further comprises a modulator 1214 and a transmitter 1216 that transmits a signal (e.g., base CQI and differential CQI) to, for instance, a base station, another mobile device, etc. Although depicted as being separate from the processor 1206, it is to be appreciated that the gatherer 1210 and/or classifier 1212 may be part of processor 1206 or a number of processors (not shown).

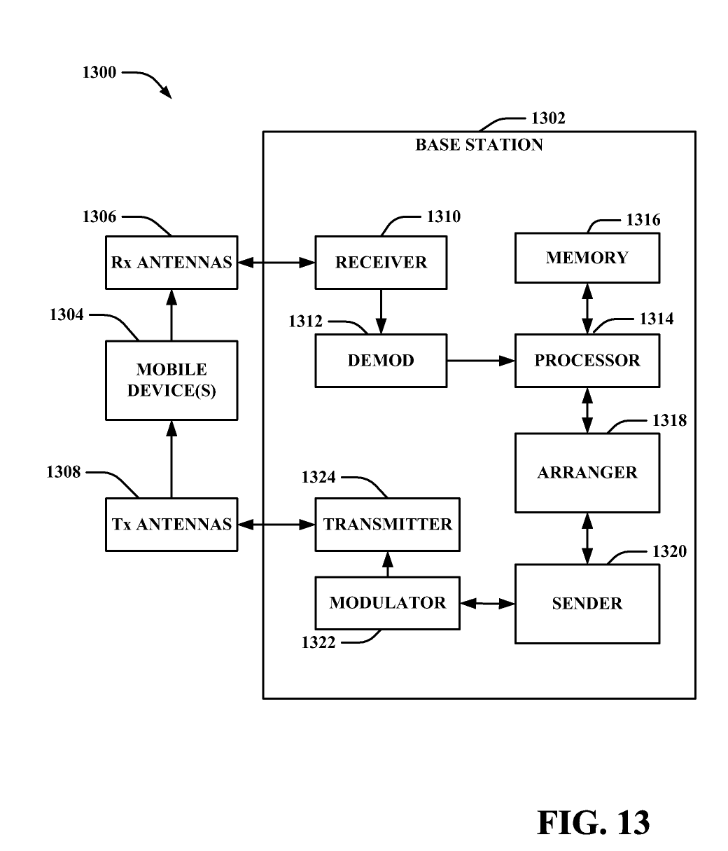

FIG. 13 is an illustration of a system 1300 that facilitates communication of scheduling unit. System 1300 comprises a base station 1302 (e.g., access point, . . . ) with a receiver 1310 that receives signal(s) from one or more mobile devices 1304 through a plurality of receive antennas 1306, and a transmitter 1322 that transmits to the one or more mobile devices 1304 through a plurality of transmit antennas 1308. Receiver 1310 can receive information from receive antennas 1306 and is operatively associated with a demodulator 1312 that demodulates received information. Demodulated symbols are analyzed by a processor 1314 that can be similar to the processor described above with regard to FIG. 12, and which is coupled to a memory 1316 that stores information related to estimating a signal (e.g., pilot) strength and/or interference strength, data to be transmitted to or received from mobile device(s) 1304 (or a disparate base station (not shown)), and/or any other suitable information related to performing the various actions and functions set forth herein.

Processor 1314 is further coupled to an arranger 1318 that organizes at least one transmission unit into a communication pattern as a function of available resources. In addition to the arranger, the processor 1314 can operatively couple to a sender 1320 emits the at least one transmission unit in accordance with the organized communication pattern. It is to be appreciated that the sender 1320 and transmitter 1324 can function together, be a single unit, and the like. Information to be transmitted may be provided to a modulator 1322. Modulator 1322 can multiplex the information for transmission by a transmitter 1326 through antenna 1308 to mobile device(s) 1304. Although depicted as being separate from the processor 1314, it is to be appreciated that the arranger 1318 and/or sender 1322 may be part of processor 1314 or a number of processors (not shown).

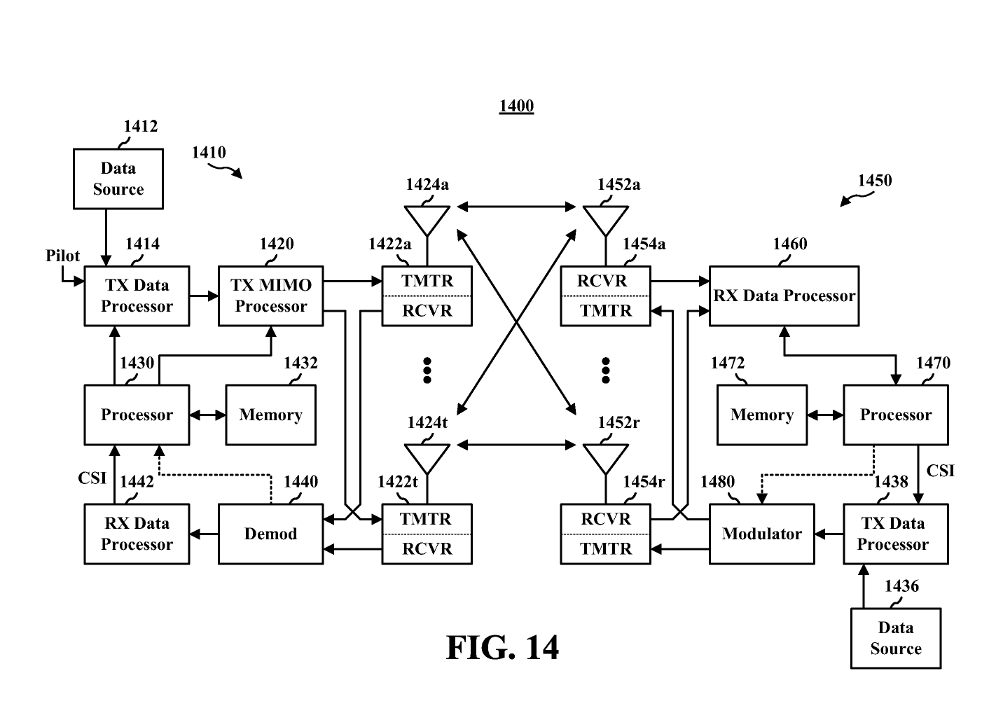

FIG. 14 shows an example wireless communication system 1400. The wireless communication system 1400 depicts one base station 1410 and one mobile device 1450 for sake of brevity. However, it is to be appreciated that system 1400 may include more than one base station and/or more than one mobile device, wherein additional base stations and/or mobile devices may be substantially similar or different from example base station 1410 and mobile device 1450 described below. In addition, it is to be appreciated that base station 1410 and/or mobile device 1450 may employ the systems (FIGS. 1-9 and 12-13) and/or methods (FIGS. 10-11) described herein to facilitate wireless communication there between.

At base station 1410, traffic data for a number of data streams is provided from a data source 1412 to a transmit (TX) data processor 1414. According to an example, each data stream may be transmitted over a respective antenna. TX data processor 1414 formats, codes, and interleaves the traffic data stream based on a particular coding scheme selected for that data stream to provide coded data.

The coded data for each data stream may be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and may be used at mobile device 1450 to estimate channel response. The multiplexed pilot and coded data for each data stream may be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream may be determined by code performed or provided by processor 1430.

The modulation symbols for the data streams may be provided to a TX MIMO processor 1420, which may further process the modulation symbols (e.g., for OFDM). TX MIMO processor 1420 then provides N_{T} modulation symbol streams to N_{T} transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1422a through 1422t are transmitted from N_{T} antennas 1424a through 1424t, respectively.

At mobile device 1450, the transmitted modulated signals are received by N_{R} antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 may receive and process the N_{R} received symbol streams from N_{R} receivers 1454 based on a particular receiver processing technique to provide N_{T} “detected” symbol streams. RX data processor 1460 may demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 may periodically determine which preceding matrix to utilize as discussed above. Further, processor 1470 may formulate a reverse link message comprising a matrix index portion and a rank value portion.

The reverse link message may comprise various types of information regarding the communication link and/or the received data stream. The reverse link message may be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from mobile device 1450 are received by antennas 1424, conditioned by receivers 1422, demodulated by a demodulator 1440, and processed by a RX data processor 1442 to extract the reverse link message transmitted by mobile device 1450. Further, processor 1430 may process the extracted message to determine which preceding matrix to use for determining the beamforming weights.

Processors 1430 and 1470 may direct (e.g., control, coordinate, manage, etc.) operation at base station 1410 and mobile device 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

It is to be understood that the embodiments described herein may be implemented in hardware, software, firmware, middleware, microcode, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they may be stored in a computer program product having a computer readable medium, machine-readable medium, such as a storage component. A code segment may represent a procedure, a function, a subprogram, a program, a routine, a subroutine, a module, a software package, a class, or any combination of code, instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

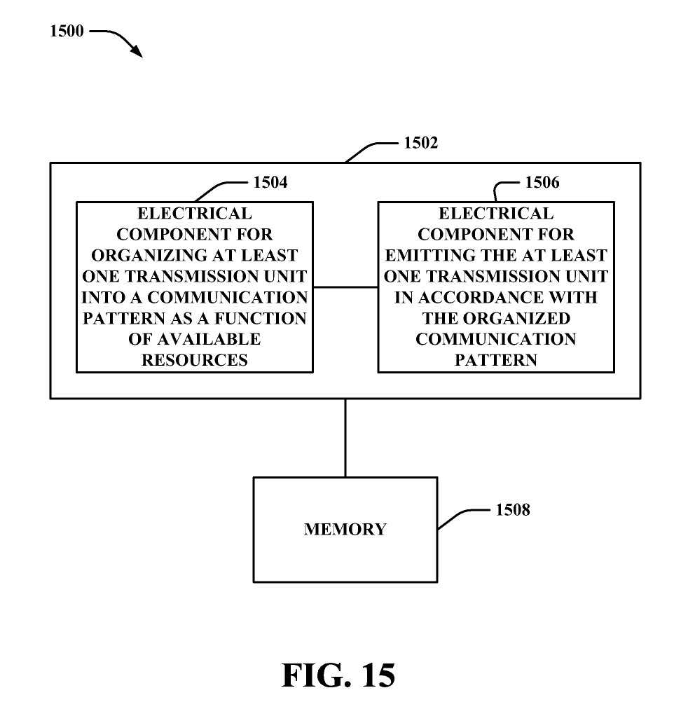

With reference to FIG. 15, illustrated is a system 1500 that facilitates communication of scheduling unit. For example, system 1500 may reside at least partially within a mobile device. It is to be appreciated that system 1500 is represented as including functional blocks, which may be functional blocks that represent functions implemented by a processor, software, or combination thereof (e.g., firmware). System 1500 includes a logical grouping 1502 of electrical components that can act in conjunction. The logical grouping 1502 can include an electrical component for organizing at least one transmission unit into a communication pattern as a function of available resources 1504. Additionally, the logical grouping 1502 can include an electrical component for emitting the at least one transmission unit in accordance with the organized communication pattern 1506. The logical grouping 1502 can also represent and include (e.g., as part of the electrical components 1504 and/or 1506) an electrical component for defining a size of the at least one transmission unit, an electrical component for dividing a scheduling unit into at least one transmission unit of the defined size, an electrical component for discovering entry of a mobile device with a coverage area, the discovered mobile device can obtain at least one transmission unit, an electrical component for determining if the discovered mobile device should receive at least of transmission unit, the determination is made as a function of security, an electrical component for creating a log of the mobile device receiving at least one transmission unit from the emission, an electrical component for determining when there is no mobile device within the coverage area, and/or an electrical component for deactivating the emitter upon a positive determination of the labeler for when there is no mobile device within the coverage area. Additionally, system 1500 may include a memory 1508 that retains instructions for executing functions associated with electrical components 1504 and 1506. While shown as being external to memory 1508, it is to be understood that one or more of electrical components 1504 and 1506 may exist within memory 1508.

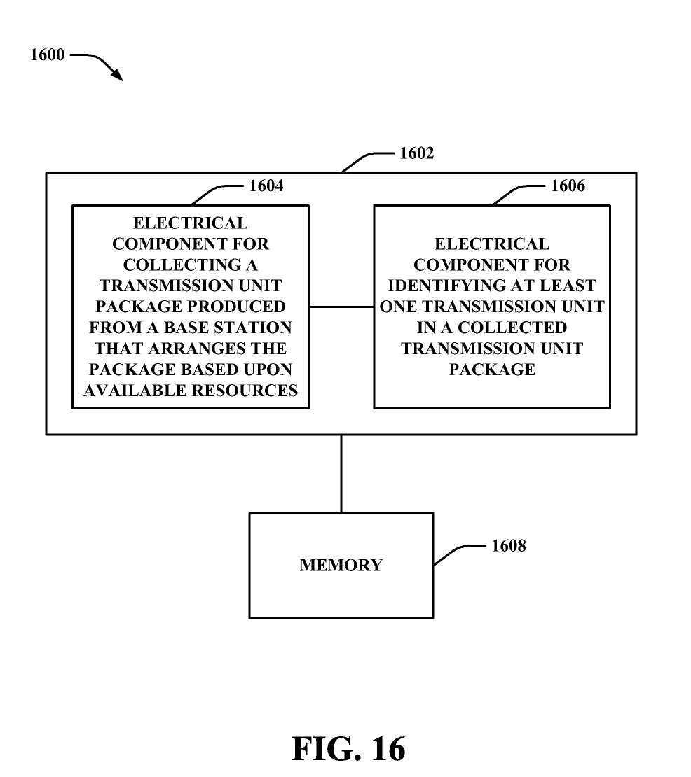

Turning to FIG. 16, illustrated is a system 1600 that calculates reduced feedback by employing successive interference operations on permuted codewords. System 1600 may reside within a base station, for instance. As depicted, system 1600 includes functional blocks that may represent functions implemented by a processor, software, or combination thereof (e.g. firmware). System 1600 includes a logical grouping 1602 of electrical components that facilitate controlling forward link transmission. For example, the logical grouping 1602 can include an electrical component for collecting a transmission unit package produced from a base station that arranges the package based upon available resources 1604. Additionally, the logical grouping 1606 can include an electrical component for identifying at least one transmission unit in a collected transmission unit package 1606. The logical grouping 1602 can also represent and include (e.g., as part of the electrical components 1604 and/or 1606) an electrical component for determining if the identified transmission unit is already appreciated, an electrical component for discarding the identified transmission unit if the transmission unit is already appreciated, an electrical component for arranging at least one identified transmission unit in a scheduling unit sequence, an electrical component for sending confirmation that the scheduling unit sequence is complete, an electrical component for recognizing that at least one transmission unit is missing such that a scheduling unit sequence is not complete, and/or an electrical component for requesting retransmission of scheduling unit. Additionally, system 1600 may include a memory 1608 that retains instructions for executing functions associated with electrical components 1604 and 1606. While shown as being external to memory 1608, it is to be understood that electrical components 1604 and 1606 may exist within memory 1608.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for delivering system information, comprising:
organizing at least one transmission unit into a communication pattern as a function of available resources; and
emitting the at least one transmission unit in accordance with the organized communication pattern.

2. The method of claim 1, further comprising defining a size of the at least one transmission unit.

3. The method of claim 2, further comprising dividing a scheduling unit into at least one transmission unit of the defined size.

4. The method of claim 1, further comprising determining available resources upon which the organization is based.

5. The method of claim 1, further comprising discovering entry of a mobile device with a coverage area, the discovered mobile device can obtain at least one transmission unit.

6. The method of claim 5, further comprising determining if the discovered mobile device should receive at least of transmission unit, the determination is made as a function of security.

7. The method of claim 5, further comprising creating a log of the mobile device receiving at least one transmission unit from the emission.

8. The method of claim 5, further comprising:
determining when there is no mobile device within the coverage area; and
deactivating the emitter upon a positive determination of the labeler for when there is no mobile device within the coverage area.

9. A wireless communication apparatus, comprising:
an arranger that organizes at least one transmission unit into a communication pattern as a function of available resources; and
a sender that emits the at least one transmission unit in accordance with the organized communication pattern.

10. The apparatus of claim 9, further comprising a categorizer that defines a size of the at least one transmission unit.

11. The apparatus of claim 10, further comprising a breaker that divides a scheduling unit into at least one transmission unit of the defined size.

12. The apparatus of claim 9, further comprising an analyzer that determines available resources upon which the organization is based.

13. The apparatus of claim 9, further comprising an identifier that discovers entry of a mobile device with a coverage area, the discovered mobile device can obtain at least one transmission unit.

14. The apparatus of claim 13, further comprising a checker that determines if the discovered mobile device should receive at least of transmission unit, the determination is made as a function of security.

15. The apparatus of claim 13, further comprising a generator that creates a log of the mobile device receiving at least one transmission unit from the sender.

16. The apparatus of claim 13, further comprising
a labeler that determines when there is no mobile device within the coverage area; and
a manager that deactivates the sender upon a positive determination of the labeler.

17. A wireless communications apparatus, comprising:
means for organizing at least one transmission unit into a communication pattern as a function of available resources; and
means for emitting the at least one transmission unit in accordance with the organized communication pattern.

18. The apparatus of claim 17, further comprising means for defining a size of the at least one transmission unit.

19. The apparatus of claim 18, further comprising means for dividing a scheduling unit into at least one transmission unit of the defined size.

20. The apparatus of claim 17, further comprising means for determining available resources upon which the organization is based.

21. The apparatus of claim 17, further comprising means for discovering entry of a mobile device with a coverage area, the discovered mobile device can obtain at least one transmission unit.

22. The apparatus of claim 21, further comprising means for determining if the discovered mobile device should receive at least of transmission unit, the determination is made as a function of security.

23. The apparatus of claim 21, further comprising means for creating a log of the mobile device receiving at least one transmission unit from the emission.

24. The apparatus of claim 21, further comprising:
means for determining when there is no mobile device within the coverage area; and
means for deactivating the emitter upon a positive determination for when there is no mobile device within the coverage area.

25. A computer program product, comprising:
a computer-readable medium comprising:
code for organizing at least one transmission unit into a communication pattern as a function of available resources; and
code for emitting the at least one transmission unit in accordance with the organized communication pattern.

26. The computer program product of claim 25, further comprising code for defining a size of the at least one transmission unit.

27. The computer program product of claim 26, further comprising code for dividing a scheduling unit into at least one transmission unit of the defined size.

28. The computer program product of claim 25, further comprising code for determining available resources upon which the organization is based.

29. The computer program product of claim 25, further comprising code for discovering entry of a mobile device with a coverage area, the discovered mobile device can obtain at least one transmission unit.

30. The computer program product of claim 29, further comprising determining if the discovered mobile device should receive at least of transmission unit, the determination is made as a function of security.

31. The computer program product of claim 29, further comprising creating a log of the mobile device receiving at least one transmission unit from the emission.

32. The computer program product of claim 29, further comprising code for:
determining when there is no mobile device within the coverage area; and
deactivating the emitter upon a positive determination for when there is no mobile device within the coverage area.

33. In a wireless communication system, an apparatus comprising:
a processor configured to:
organize at least one transmission unit into a communication pattern as a function of available resources; and
emit the at least one transmission unit in accordance with the organized communication pattern.

34. The apparatus of claim 33, the processor is further configured to define a size of the at least one transmission unit.

35. The apparatus of claim 34, the processor is further configured to divide a scheduling unit into at least one transmission unit of the defined size.

36. The apparatus of claim 33, the processor is further configured to determine available resources upon which the organization is based.

37. The apparatus of claim 33, the processor is further configured to discover entry of a mobile device with a coverage area, the discovered mobile device can obtain at least one transmission unit.

38. The apparatus of claim 37, the processor is further configured to determine if the discovered mobile device should receive at least of transmission unit, the determination is made as a function of security.

39. The apparatus of claim 37, the processor is further configured to create a log of the mobile device receiving at least one transmission unit from the emission.

40. The apparatus of claim 37, the processor is further configured to:
determine when there is no mobile device within the coverage area; and
deactivate the emitter upon a positive determination for when there is no mobile device within the coverage area.

41. A method for processing scheduling unit, comprising:
collecting a transmission unit package produced from a base station that arranges the package based upon available resources; and
identifying at least one transmission unit in a collected transmission unit package.

42. The method of claim 41, further comprising:
determining if the identified transmission unit is already appreciated; and
discarding the identified transmission unit if the transmission unit is already appreciated.

43. The method of claim 41, further comprising arranging at least one identified transmission unit in a scheduling unit sequence.

44. The method of claim 43, further comprising sending confirmation that the scheduling unit sequence is complete.

45. The method of claim 41, further comprising:
recognizing that at least one transmission unit is missing such that a scheduling unit sequence is not complete; and
requesting retransmission of scheduling unit.

46. A wireless communication apparatus, comprising:
a gatherer that collects a transmission unit package produced from a base station that arranges the package based upon available resources; and
a classifier that identifies at least one transmission unit in a collected transmission unit package.

47. The apparatus of claim 46, further comprising:
a retainer that determines if the identified transmission unit is already appreciated; and
a disposer that discards the identified transmission unit if the transmission unit is already appreciated.

48. The apparatus of claim 46, further comprising a placer that arranges at least one identified transmission unit in a scheduling unit sequence.

49. The apparatus of claim 48, further comprising a conveyer that sends confirmation that the scheduling unit sequence is complete.

50. The apparatus of claim 46, further comprising:
a distinguisher that recognizes that at least one transmission unit is missing such that a scheduling unit sequence is not complete; and
an inquirer that requests retransmission of scheduling unit.

51. A wireless communications apparatus, comprising:
means for collecting a transmission unit package produced from a base station that arranges the package based upon available resources; and
means for identifying at least one transmission unit in a collected transmission unit package.

52. The apparatus of claim 51, further comprising:
means for determining if the identified transmission unit is already appreciated; and
means for discarding the identified transmission unit if the transmission unit is already appreciated.

53. The apparatus of claim 51, further comprising means for arranging at least one identified transmission unit in a scheduling unit sequence.

54. The apparatus of claim 53, further comprising means for sending confirmation that the scheduling unit sequence is complete.

55. The apparatus of claim 51, further comprising:
means for recognizing that at least one transmission unit is missing such that a scheduling unit sequence is not complete; and
means for requesting retransmission of scheduling unit.

56. A computer program product, comprising:
a computer-readable medium comprising:
code for collecting a transmission unit package produced from a base station that arranges the package based upon available resources; and
code identifying at least one transmission unit in a collected transmission unit package.

57. The computer program product of claim 56, further comprising code for:
determining if the identified transmission unit is already appreciated; and
discarding the identified transmission unit if the transmission unit is already appreciated.

58. The computer program product of claim 56, further comprising code for arranging at least one identified transmission unit in a scheduling unit sequence.

59. The computer program product of claim 58, further comprising code for sending confirmation that the scheduling unit sequence is complete.

60. The computer program product of claim 56, further comprising code for:
recognizing that at least one transmission unit is missing such that a scheduling unit sequence is not complete; and
requesting retransmission of scheduling unit.

61. In a wireless communication system, an apparatus comprising:
a processor configured to:
collect a transmission unit package produced from a base station that arranges the package based upon available resources; and
identify at least one transmission unit in a collected transmission unit package.

62. The apparatus of claim 61, the processor is further configured to:
determine if the identified transmission unit is already appreciated; and
discard the identified transmission unit if the transmission unit is already appreciated.

63. The apparatus of claim 61, the processor is further configured to arrange at least one identified transmission unit in a scheduling unit sequence.

64. The apparatus of claim 63, the processor is further configured to send confirmation that the scheduling unit sequence is complete.

65. The apparatus of claim 61, the processor is further configured to:
recognize that at least one transmission unit is missing such that a scheduling unit sequence is not complete; and
request retransmission of scheduling unit.
